(19) United States
(12) Patent Application Publication
(10) Pub. No.: US 2008/0059584 A1
(43) Pub. Date: Mar. 6, 2008

(54) METHOD AND APPARATUS FOR SHARING RESOURCE ADDRESSES

(76) Inventors: Cindy Lam, Middle Village, NY (US); Calvin Wu, Middle Village, NY (US); Ka Keung Lee, Richmond (CA)

Correspondence Address: PATTERSON & SHERIDAN L.L.P., 595 SHREWSBURY AVE, STE 100, FIRST FLOOR, SHREWSBURY, NJ, 07702, US

(21) Appl. No.: 11/850,770

(22) Filed: Sep. 6, 2007

Related U.S. Application Data
(60) Provisional application No. 60/842,455, filed on Sep. 6, 2006.

(51) Int. Cl. G06F 15/16; G06F 3/048

(52) U.S. Cl. 709/205; 715/206

(57) ABSTRACT

A method for sharing bookmarks by receiving client bookmarks at a server and selectively sharing the client bookmarks with other clients.

### CROSS-REFERENCE TO RELATED APPLICATIONS

This application claims the benefit of commonly owned U.S. Provisional Application No. 60/842,455, filed on Sep. 6, 2006, which is incorporated herein by reference.

### FIELD OF THE INVENTION

The present invention relates to computer networks in general and, more specifically, to a method and apparatus for sharing resource addresses among clients and other entities within a computer network.

### BACKGROUND OF THE INVENTION

Internet browser programs and other online services such as Internet Explorer from Microsoft Corp., as well as competing browser programs (Firefox, Safari and so on), allow a user to “bookmark” or save the addresses of interesting Web pages or other on-line resources so that the resources may be easily accessed at a later date by the user. One user may share a bookmark(s) or a bookmark list with other users by providing a file to other users that includes all the bookmarks or sending/providing the bookmark(s) via other means, such as email. These multi-step processes are cumbersome and may be overly inclusive, since bookmarks that are not of interest to the other users may be provided within the shared bookmark list.

### SUMMARY OF THE INVENTION

Various deficiencies of the prior art are addressed by a method and apparatus for sharing resource addresses. A method for sharing a resource address according to one embodiment of the invention comprises receiving, at a server, address information pertaining to a website being accessed by a client; and storing the address information in a memory region associated with the client; wherein the client is able to share address information with other users or members of a group.

### BRIEF DESCRIPTION OF THE DRAWINGS

The teachings of the present invention can be readily understood by considering the following detailed description in conjunction with the accompanying drawings, in which:

FIG. 1 depicts a user screen for a website associated with an embodiment of the invention;

FIG. 2 depicts an active user screen for the website of FIG. 1;

FIG. 3 depicts imagery of a user interface adapted to enable the association of one or more contacts and/or groups to a particular button or text link;

FIG. 4 depicts a screenshot of a news-related website viewed via an Internet browsing program;

FIG. 5 depicts imagery of a pop-up window or css layer (html) generated in response to user activation of an active button or text link; and

FIG. 6 depicts a high-level block diagram of a networked system suitable for implementing an embodiment of the invention.

To facilitate understanding, identical reference numerals have been used, where possible, to designate identical elements that are common to the figures.

### DETAILED DESCRIPTION

The invention comprises a method, apparatus, service, and computer program product enabling the sharing and/or transfer of bookmarks between users, such as Internet users. It is applicable to webpage bookmarks or URLs including IP addresses, filenames and the like. Thus, the invention has applicability to the rapid sharing of location or address information for any type of resource, beyond the web page resources primarily described below.

In one embodiment, a first share function is implemented wherein a bookmark associated with a webpage presently being viewed by a user is automatically transmitted to a service web site which in turn stores the bookmark in a storage location for each member of a predetermined group of users. In this manner, a member of a group sharing an interest may convey to other members of that group the bookmark of a webpage dealing with an interest.

In another embodiment, rather than having the bookmark transferred to a predefined group of users, a dialog box or pop-up window or css layer (html) is displayed to the user who may then choose who to share the bookmark with (e.g., a group of like-minded users, family, friends and the like).

The above and other embodiments may be advantageously combined to provide a customized/adaptable solution to users.

A system implementing the present invention comprises a service web site having associated with a URL that is used to receive and disseminate bookmarks between users. The service website may be used to implement various functions or mechanisms, such as the above-described share mechanisms, advertising mechanisms and the like. In this context, the term “mechanisms” is defined as a functionality deliverable to a client via the service website. The functionality may be deliverable as an applet, a standard service website interaction and so on.

The “share”, “advertisement” and other mechanisms are generally adapted to enhancing the utility of, for example, the Internet by quickly providing like-minded users with bookmarks pointing to pages of common interest. Users may be members of multiple groups or interest groups.

In one embodiment of the invention, a button or text link is provided on a user's toolbar (e.g., a browser's link bar) within a browser program or embedded in other websites. Activation of the button results in the transfer to the service website of the currently viewed webpage (or least the URL pointing to the webpage) as well as indicia of the activated button or text link.

Within the context of the invention, the term “button” is used to define a graphical button and/or text link located within a toolbar or other area of an application or website, such as a toolbar within an Internet Explorer, Firefox, Safari or other Internet browser application.

Common Features of HOGEE Share and ShareWith:

A web application that allows users to send bookmarks to other users via a button provided by HOGEE.

The button, provided by HOGEE for the described sharing functionality, is available in HOGEE web site and can be dragged-and-dropped, saved and/or installed to the end user's browser link bar or webpage. Please note that where the end users can drag-and-drop a button may be different depending on the type and versions of the browser.

HOGEE “Share”:

A two step process for the user to share bookmarks.

When the user clicks on the ‘HOGEE share’ button, a mechanism is initiated where an information box/pop-up window or css layer (html) will appear (on top of the page the user is viewing) with information including, but not limited to, the current URL and title of the page. The user can select or type-in email addresses, or select a group or multiple groups, to send this bookmark to. The sent bookmark, its URL along with (including but not limited to) the title description of the viewing page, will be stored in the recipients' bookmark inbox/storage location. The sender will also have a record of the sent bookmark information in their account.

HOGEE “ShareWith”:

A one step process for the user to share bookmarks.

When the user clicks on the ‘HOGEE ShareWith” button, a mechanism is initiated wherein the current web page URL (including but not limited to the title and/or description of the page) in the active browser window is sent to a pre-specified recipient or group of recipients.

Thus, after initially setting up contacts and/or interest groups comprising context, a “one click” mechanism for rapidly disseminating bookmark information is provided. The sender will also have a record of the sent bookmark information in their account. Bookmark information may be provided to users directly or via the Hogee service website. In one embodiment, a service website stores a copy of each user's bookmark list which may be periodically synchronized to a local copy of each user's bookmark list.

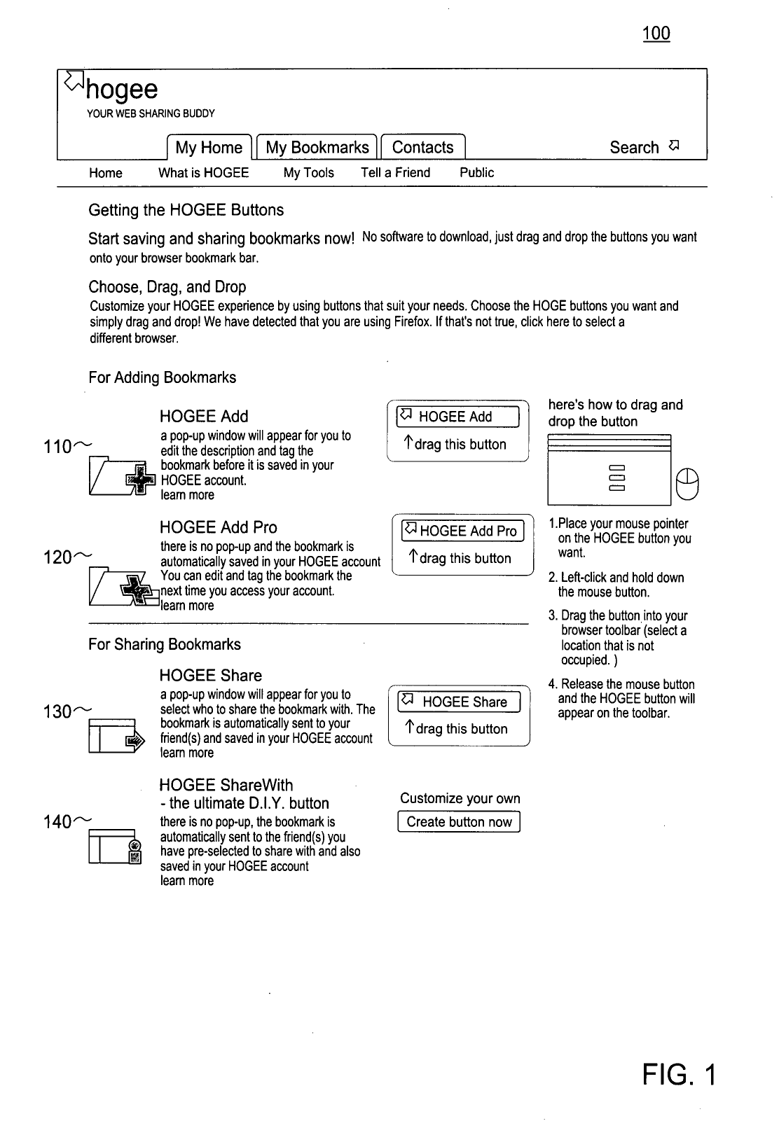

FIG. 1 depicts a user screen for a visitor to the Hogee website. Specifically, a user visits the Hogee website to get Hogee buttons for integration into, for example, the toolbar of the user's browser. Each of the buttons integrated into the Web browser toolbar implements a specific Hogee function. The Hogee buttons are related to functions such as depicted in FIG. 1, illustratively Hogee Add 110, Hogee AddPro 120, Hogee Share 130 and Hogee ShareWith 140. Other buttons may be used. For example, and “all in one” button is used in one embodiment to generate a summary or menu of all the functions associated with a particular user.

To activate these buttons, they must be dragged-dropped or otherwise installed or saved in a user's web browser or webpage. Such installation may be effected via a “drag and drop” process, a “bookmark add” process or any other process by which an application toolbar or webpage is modified to include a new button, the new button representing a predefined functionality.

It will be appreciated by those skilled in the art that while FIG. 1 depicts four buttons or text links having different functions, more or fewer buttons or text links may be used. For example, an additional button or text link may be provided to instantiate a tab-based window function rather than a standard function. Additional functionality such as described elsewhere in the instant application may be invoked using a button or text link such as described herein with respect to FIG. 1. It will also be appreciated that the various buttons or text links may be installed in a browser using a drag and drop technique, including within a webpage or the otherwise associated with any webpage or resource address of interest.

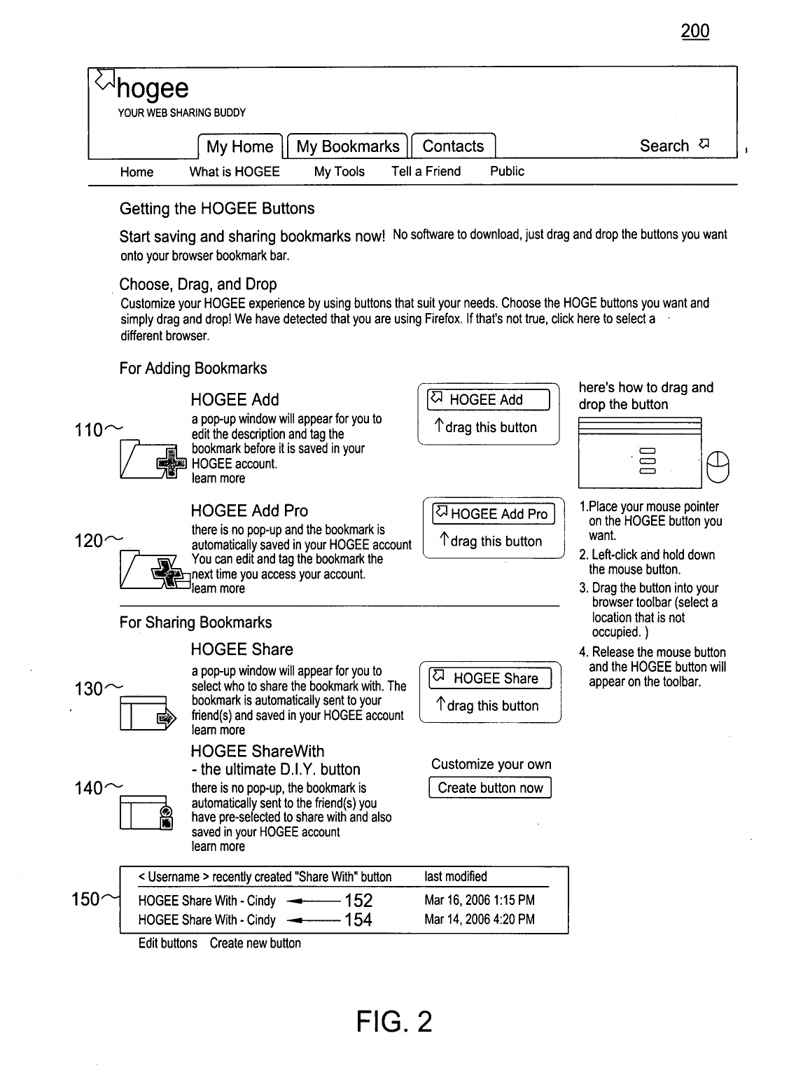

FIG. 2 depicts an active user screen for a visitor to the Hogee website. The same buttons (110-140) of FIG. 1 are present, with the addition of a button name 150 to be associated with the ShareWith button. Two button names; namely, Cindy 152 and Calvin 154 are depicted as being associated with the ShareWith button group 150. This means that activation at a user browser of the ShareWith button will result in the URL associated with the present webpage (i.e., a bookmark entry) to be sent to recipients associated with the button named Cindy and Calvin automatically.

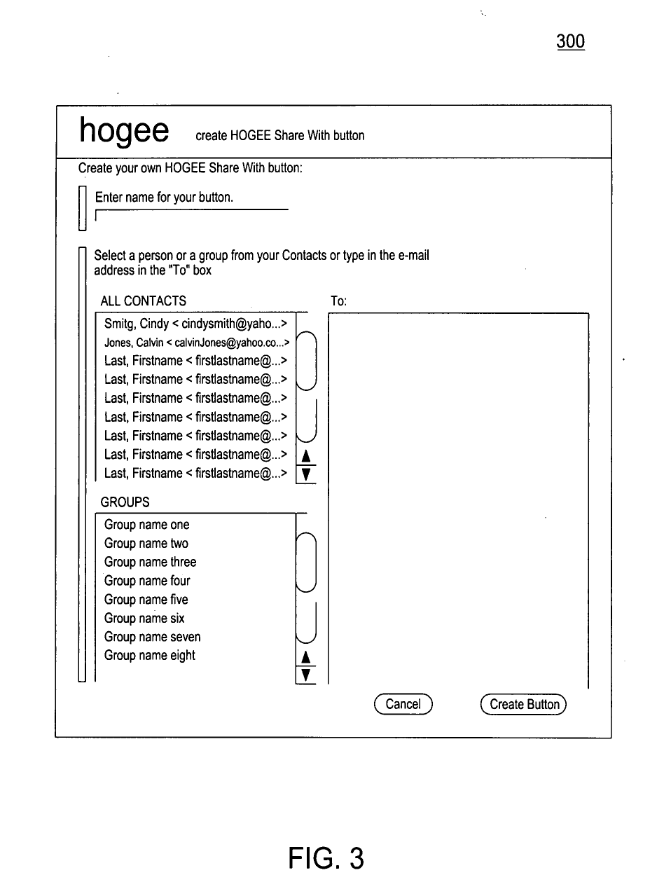

FIG. 3 depicts imagery of a user interface adapted to enable the association of one or more contacts and/or groups to particular button or text link. In this manner, individual contacts and/or groups may be simultaneously provided with the bookmark of a current website, document, network resource, message, or other elements upon activation of a button corresponding to the contacts and/or groups.

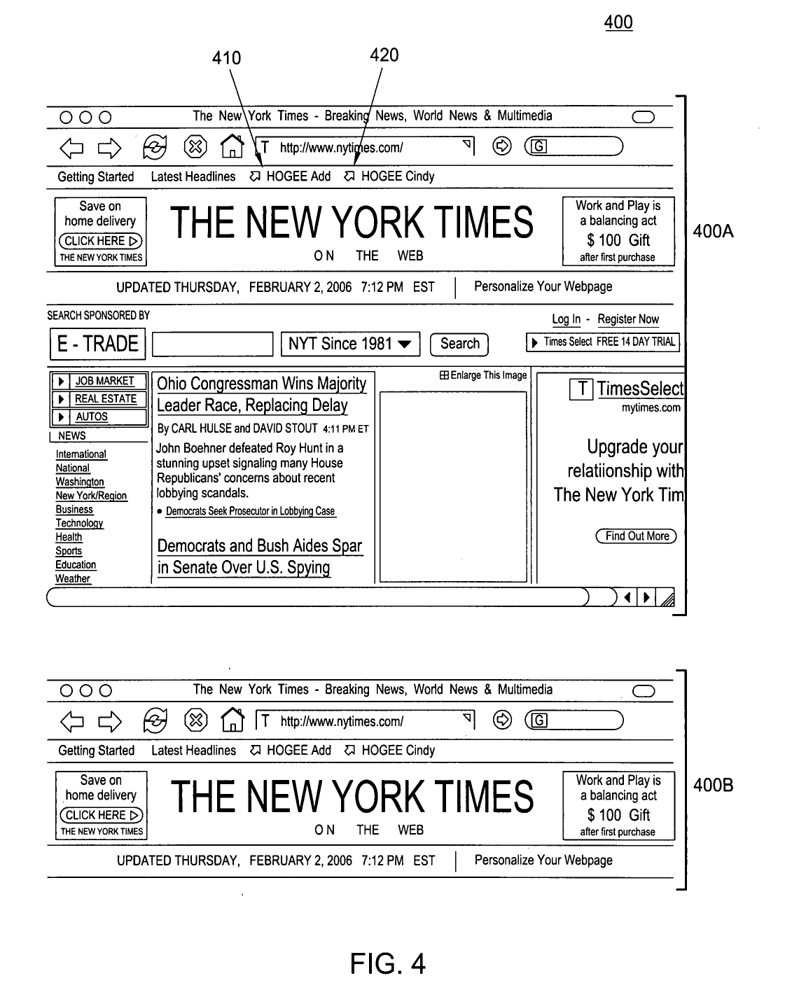

FIG. 4 depicts a screenshot of a news-related website 400A viewed via an Internet browsing program. A toolbar associated with the Internet browsing program is depicted as horizontally disposed above a content frame, the toolbar including “Hogee Add” 410 and to “Hogee Cindy” 420 buttons. Activation of the Hogee Cindy button (per 400B) results in the URL or bookmark (i.e., www.NYTimes.com) of an active resource (e.g., a presently viewed webpage) or a related or inactive resource being transmitted to the contacts/groups associated with the button “Hogee Cindy”.

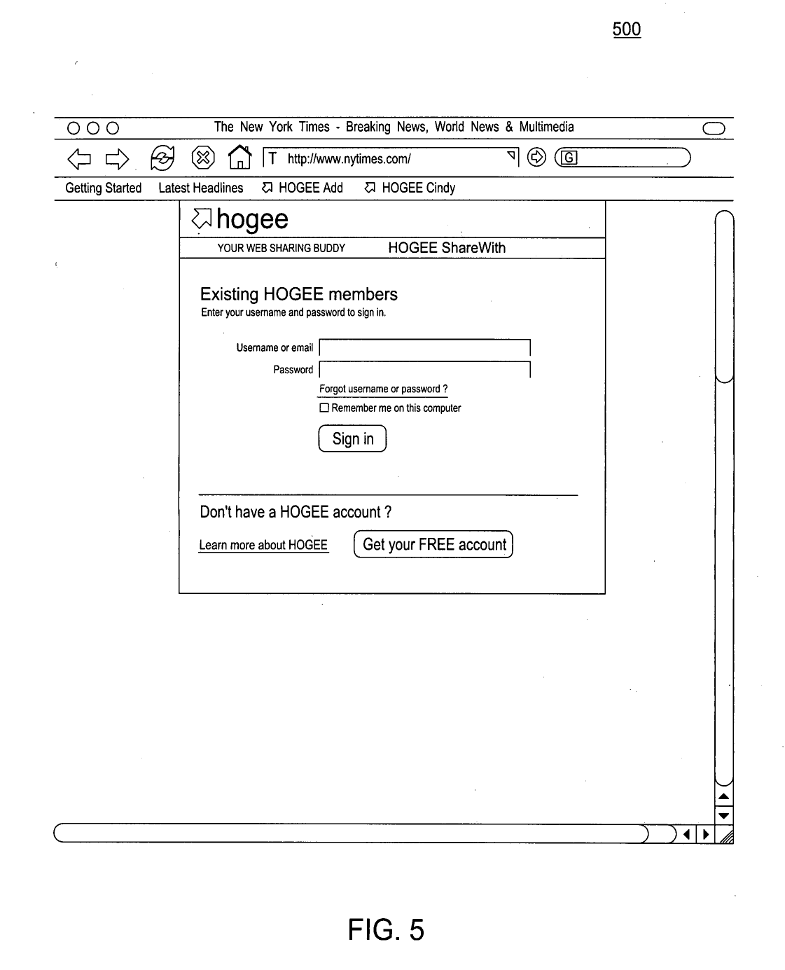

FIG. 5 depicts imagery of a pop-up window or css layer (html) generated in response to user activation of an active button or text link. Specifically, activation of a Hogee button (per 400B) may result in the generation of a pop-up window or css layer (html) such as depicted in FIG. 5, the window or css layer (html) offering a user interface enabling the creation or further use of the various Hogee functions. The window or css layer (html) does not pop-up if the user utilizes the “remember me” function (i.e., a cookie is stored locally with the relevant information). Generally speaking, the window or css layer (html) pops up when the user is not logged in (and has not used the remember me function).

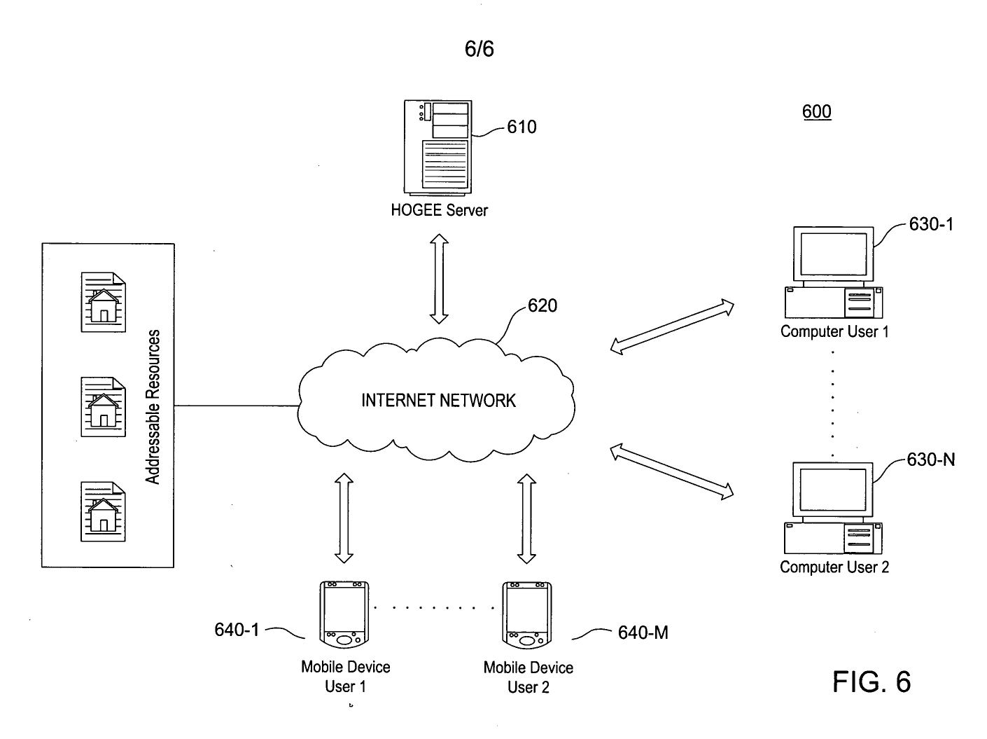

FIG. 6 depicts a high-level block diagram of a networked system suitable for implementing the current invention. Specifically, FIG. 6 depicts a connected network 620 such as the Internet which is in communication with a Hogee server 610, a plurality of computer users 630, a plurality of mobile device users 640, and a number of addressable resources. Each of the computer users 630 and mobile device users 640 represents a computing device including memory, input-output circuitry and processing circuitry operable to execute an application program, such as a browser, word processor and the like in which a user interface is generated and displayed, the user interface including toolbar or similar imagery in which buttons as described herein may be disposed. Thus, each of the computing devices 630 and 640 are operable to achieve the client portion of the invention described herein.

As described in the previous figures, each computer or mobile device user may define particular buttons to be associated with one or more users or user groups. Such definitions are stored within the Hogee server 610 (the local storage is also envisioned within the context of the invention).

Upon activation of a button via a user interface, the user computing device transmits to the Hogee server both identifier of the button activated and the URL of the active resource (e.g., a webpage or file). The URL of the active resource is then transmitted to each contact associated with that button. The transfers may be affected via a synchronization process wherein user bookmark lists are synchronized between user devices and the Hogee server. Alternatively, the bookmark is merely provided to each user for subsequent inclusion in a local bookmark list.

Although each user computing device is depicted as a general purpose computer that is programmed to perform various control functions in accordance with the present invention, the invention can be implemented in hardware as, for example, an application specific integrated circuit (ASIC) or field programmable gate array (FPGA). As such, the process steps described herein are intended to be broadly interpreted as being equivalently performed by software, hardware or a combination thereof.

The computing devices may be operably coupled to a number of devices or systems, such as input devices (e.g., a keyboard, mouse, remote control and the like), a network (e.g., network 620), a display device and so on.

Various embodiments of the invention may be implemented as a computer program product wherein computer instructions, when processed by a computer, adapt the operation of the computer such that the methods and/or techniques of the present invention are invoked or otherwise provided. Instructions for invoking the inventive methods may be stored in fixed or removable media, transmitted via a data stream in a broadcast media, and/or stored within a working memory within a computing device operating according to the instructions.

The general process described herein comprises, for each user, setting up accounts with the Hogee system, setting up buttons for one or more applications to enable the sharing of bookmarks, dragging or otherwise saving or installing the buttons in the various applications, and utilizing the buttons to transfer bookmark information to corresponding contacts or contact groups.

While the invention provides enhanced functionality within the context of Web browsing, file searching and the like, the invention is applicable to additional applications such as document processing applications (i.e., Microsoft Word and the like), electronic mail applications (i.e., Microsoft Outlook and the like) and so on. Thus, the discussions herein associated with toolbars other functions associated with the invention should be broadly construed as applicable to multiple software applications.

In a server-side implementation of the invention, a method for sharing an resource address according to one embodiment includes the steps of receiving, at a server, address information pertaining to a website accessed by a first client; and storing the address information in respective memory regions associated with the first client and at least one additional client; wherein each client retrieves address information from its respective memory region. In an alternate embodiment, the memory region associated with each client comprises a storage location and the address information comprises a bookmark. An alternate embodiment further includes the step of receiving, at the server, a share message indicative of the client storage locations used to store the address information. In an alternate embodiment the client storage locations used to store the address information are selected by user interaction at the first client each time a bookmark is to be shared. In an alternate embodiment the client storage locations used to store the address information are defined by client membership in a group of clients. In an alternate embodiment the share message is generated when a user selects a displayed button or text link associated with a bookmark share function. An alternate embodiment further includes the step of receiving, at the server, an add message indicative of a bookmark to be included in the storage location associated with the client. In an alternate embodiment the add message is generated by the client each time a bookmark is stored by the client. In an alternate embodiment the client generates an image-representative signal which includes a user selectable button or text link indicative of at least one of an add function or a share function. In an alternate embodiment the user selectable button or text link is included within imagery associated with a website. An alternate embodiment further includes the step of in response to a client request, establishing an account for the client including a memory region. An alternate embodiment further includes the step of in response to a client request, associating a client with a group of clients. In an alternate embodiment the group comprises clients having a shared interest.

In a client-side implementation of the invention, a method according to one embodiment includes transmitting, toward a server from a first client, address information pertaining to a website being accessed, said address information being adapted to be stored at the server in respective memory regions associated with the first client and at least one additional client; and retrieving, from a server memory region associated with the first client, address information pertaining to websites accessed by other clients. In an alternate embodiment the memory region associated with each client comprises a storage location and the address information comprises a bookmark.

Although various embodiments that incorporate the teachings of the present invention have been shown and described in detail herein, those skilled in the art can readily devise many other varied embodiments that still incorporate these teachings.

What is claimed is:

1. A method for sharing a resource address, comprising:
receiving, at a server, address information pertaining to a website accessed by a first client; and
storing the address information in respective memory regions associated with the first client and at least one additional client;
wherein each client retrieves address information from its respective memory region.

2. The method of claim 1, wherein the memory region associated with each client comprises a storage location and the address information comprises a bookmark.

3. The method of claim 2, further comprising:
receiving, at the server, a share message indicative of the client storage locations used to store the address information.

4. The method of claim 3, wherein the client storage locations used to store the address information are selected by user interaction at the first client each time a bookmark is to be shared.

5. The method of claim 3, wherein the client storage locations used to store the address information are defined by client membership in a group of clients.

6. The method of claim 4, wherein the share message is generated when a user selects a displayed button or text link associated with a bookmark share function.

7. The method of claim 2, further comprising:
receiving, at the server, an add message indicative of a bookmark to be included in the storage location associated with the client.

8. The method of claim 7, wherein the add message is generated by the client each time a bookmark is stored by the client.

9. The method of claim 2, wherein the client generates an image-representative signal which includes a user selectable button or text link indicative of at least one of an add function or a share function.

10. The method of claim 9, wherein the user selectable button or text link is included within imagery associated with a website.

11. The method of claim 1, further comprising:
in response to a client request, establishing an account for the client including a memory region.

12. The method of claim 5, further comprising:
in response to a client request, associating a client with a group of clients.

13. The method of claim 12, wherein said group comprises clients having a shared interest.

14. A computer program product wherein computer instructions, when processed by a computer, adapt the operation of the computer to provide a method for sharing a resource address, comprising:
receiving, at a server, address information pertaining to a website accessed by a first client; and
storing the address information in respective memory regions associated with the first client and at least one additional client;
wherein each client retrieves address information from its respective memory region.

15. A computer readable medium for storing computer instructions which, when processed by a computer, adapt the operation of the computer to provide a method for sharing a resource address, comprising:
receiving, at a server, address information pertaining to a website accessed by a first client; and
storing the address information in respective memory regions associated with the first client and at least one additional client;
wherein each client retrieves address information from its respective memory region.

16. A method, comprising:
transmitting, toward a server from a first client, address information pertaining to a website being accessed, said address information being adapted to be stored at the server in respective memory regions associated with the first client and at least one additional client; and
retrieving, from a server memory region associated with the first client, address information pertaining to websites accessed by other clients.

17. The method of claim 16, wherein the memory region associated with each client comprises a storage location and the address information comprises a bookmark.
